(19) United States
(12) Patent Application Publication
(10) Pub. No.: US 2008/0103994 A1
(43) Pub. Date: May 1, 2008

(54) Narrowcasting religious activity

(75) Inventors: Ran Keren, Tel-Aviv (IL); Josef Confino, Givataim (IL); Igal Dror, Tel-Aviv (IL)

Correspondence Address: Martin D. Moynihan;PRTSI, Inc., P.O. Box 16446, Arlington, VA, 22215, US

(73) Assignee: MoDefine Ltd., Nicosia (CY)

(21) Appl. No.: 11/589,143

(22) Filed: Oct. 30, 2006

(51) Int. Cl. G06Q 90/00

(52) U.S. Cl. 705/500

(57) ABSTRACT

A method for narrowcasting performance of a personalized ecclesiastical act at an ecclesiastically significant location, the narrowcasting being over a network, the method comprising the steps of: a) receiving at the ecclesiastically significant location at least one request for performing a personalized ecclesiastical act, from a respective remote user; b) at the ecclesiastically significant location performing the ecclesiastical act; c) narrowcasting the performance of the ecclesiastical act to the remote user; and d) billing the remote user for the narrowcasting.

### FIELD AND BACKGROUND OF THE INVENTION

The present invention relates to a narrowcasting system and, more particularly, but not exclusively to a system and method for narrowcasting religious activity, or providing for personalized ecclesiastical acts, perhaps to be performed at ecclesiastically significant locations, to the devout over a network for a fee.

Religious activities are now distributed worldwide through a variety of broadcasting channels.

For example, each year, the Vatican Television Center (CTV) conducts around 130 live broadcasts of events inside the Vatican (the Angelus, the Pope's General Audience and other events or celebrations). In addition there are live broadcasts associated with the Holy Father's trips in Italy and abroad.

Live broadcasts are transmitted by other Catholic television networks, as well. On request by international TV networks, CTV coordinates satellite link-ups in order to relay the signal anywhere in the world. On an experimental basis, the Angelus is currently transmitted directly from the Vatican via Intelsat towards America every Sunday. CTV also promotes a project which includes the interactive and multi-medial diffusion of certain major events marking the start of the Third Millennium. CTV further covers the daily public activities of the Holy Father and the main events that take place within the Apostolic See.

However, the content provided by CTV and other religious channel, is broadcasted to a rather general public, rather than being narrowcast to a small audience, or monocast to a certain receiver.

Narrowcasting has traditionally been understood as the dissemination of information (usually by radio or television) to a narrow audience, not to the general public. Some forms of narrowcasting involve directional signals or use of encryption. In the context of out-of-home advertising, this term often refers to the display of content on a digital signage network. Monocasting involves the dissemination of information (usually by radio, television, or the Internet network) to a single receiver.

There is thus a widely recognized need for, and it would be highly advantageous to have, a system devoid of the above limitations.

### SUMMARY OF THE INVENTION

According to one aspect of the present invention there is provided a method for narrowcasting performance of a personalized ecclesiastical act at an ecclesiastically significant location, the narrowcasting being over a network, the method comprising the steps of: a) receiving at the ecclesiastically significant location at least one request for performing a personalized ecclesiastical act, from a respective remote user; b) at the ecclesiastically significant location performing the ecclesiastical act; c) narrowcasting the performance of the ecclesiastical act to the remote user; and d) billing the remote user for the narrowcasting.

According to a second aspect of the present invention there is provided an apparatus for narrowcasting performance of a personalized ecclesiastical act at an ecclesiastically significant location, the narrowcasting being over a network, the apparatus comprising: a) a request receiver, configured to receiving at least one request for narrowcasting performance of a personalized ecclesiastical act at the ecclesiastically significant location, from a respective re mote user; b) a narrowcaster, associated with the request receiver, and configured to narrowcast performance of the personalized ecclesiastical act at the ecclesiastically significant location to the remote user; and c) a billing data generator, associated with the narrowcaster, and configured to generate billing data, usable for billing the remote user for the narrowcasting.

According to a third aspect of the present invention there is provided a method for narrowcasting performance of an ecclesiastical act at an ecclesiastically significant location, the narrowcasting being over a network, the method comprising the steps of:

a) receiving at least one request for narrowcasting performance of an ecclesiastical act, from a respective remote user; b) at the ecclesiastically significant location performing the ecclesiastical act; c) narrowcasting the performance of the ecclesiastical act to the remote user; and d) billing the remote user for the narrowcasting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof.

For example, as hardware, selected steps of the invention could be implemented as a chip or a circuit. As software, selected steps of the invention could be implemented as a plurality of software instructions being executed by a computer using any suitable operating system.

In any case, selected steps of the method and system of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. The description taken with the drawings making apparent to those skilled in the art how the several forms of the invention may be embodied in practice.

In the drawings:

FIG. 1 is a simplified flowchart illustrating a method for narrowcasting performance of a religious activity, according to a preferred embodiment of the present invention.

FIG. 2 is a simplified block diagram illustrating an apparatus for narrowcasting performance of a religious activity according to a preferred embodiment of the present invention.

FIG. 3 is a second simplified block diagram illustrating an apparatus for narrowcasting performance of a religious activity, according to a preferred embodiment of the present invention.

FIG. 4 is a simplified flowchart illustrating a method for ordering narrowcasting performance of a religious activity, using a web site, according to a preferred embodiment of the present invention.

### DESCRIPTION OF THE PREFERRED EMBODIMENTS

The present embodiments comprise a method and apparatus for narrowcasting performance of religious activity, and more particularly for providing the faithful with the ability to watch, over the Internet, an ecclesiastical act performed at an ecclesiastically significant location, preferably personalized, for a fee.

As described in further detail hereinabove, Narrowcasting has traditionally been understood as the dissemination of information (usually by radio or television) to a narrow audience, not to the general public.

Monocasting is a form of narrowcasting involving the dissemination of information (usually by radio or television) to single receiver.

According to a preferred embodiment of the present invention, there is provided a method for monocasting performance of religious activities, to a remote user.

For example, the method may allow Christian believers from a variety of geographical locations to request (say through a web site) priests in the churches of the holy land to carry out religious activities, for the believers. The religious activities may include, but are not limited to: lighting a candle for a saint, or in memory of a believer's relative, praying for the good health of a friend of the believer, blessing the believer, etc.

According to a preferred embodiment of the present invention, the religious activity performed at the request of the believer is monocasted to the believer as a personalized service.

For example, a certain believer may issue a request to be blessed by a priest in the Basilica of the Nativity, in Bethlehem. The believer may further ask to be blessed at a certain time.

The request is delivered to a priest in the Basilica of the Nativity via any suitable medium, for example the Internet. At the requested time, the priest attends the chapel of the church. As the priest starts the blessing, audio-visual equipment (typically a webcam but also any other kind of a camera, a microphone, etc) captures the religious activity of the blessing. The captured religious activity is monocasted to the believer, say through the web. The believer may be billed for the monocasting of the blessing.

The principles and operation of a method and a system, according to a preferred embodiment of the present invention, may be better understood with reference to the drawings and accompanying description.

Before explaining at least one embodiment of the invention in detail, it is to be understood that the invention is not limited in its application to the details of construction and the arrangement of the components set forth in the following description or illustrated in the drawings.

The invention is capable of other embodiments or of being practiced or carried out in various ways. Also, it is to be understood that the phraseology and terminology employed herein is for the purpose of description and should not be regarded as limiting.

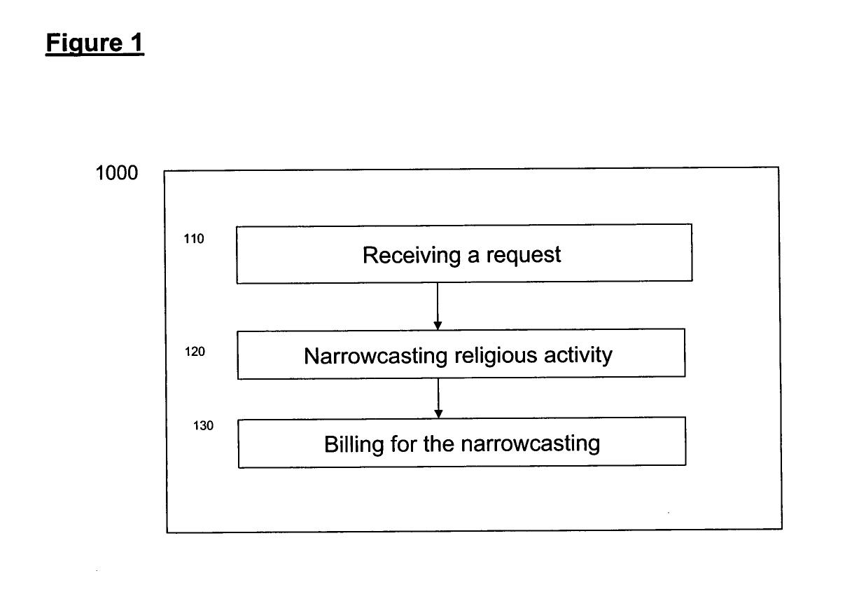

Reference is now made to FIG. 1, which is a simplified flowchart illustrating a method for narrowcasting performance of a religious activity, according to a preferred embodiment of the present invention.

According to method 1000 there is received 110 one or more request(s) for narrowcasting one or more religious activities, from a respective remote user.

The request may be received 110 through a web site, as described in further detail hereinbelow. Through the web site, the remote user may be allowed to choose which activity is to be performed, and where the activity is to be performed. The remote user may also be allowed to choose in what time frame of available time frames the religious activity is to be performed.

Next, the religious activity is performed and is narrowcast 120 to the remote user. Optionally, the religious activity may be narrowcast to other users, say to family members or friends of the remote user. Preferably, the remote user may be allowed to choose or determine whom the religious activity is to be narrowcast to, say through a web site, as described in further detail hereinbelow.

The remote user, who requests the narrowcasting, may be billed 130 for the narrowcasting of the religious activity. Optionally, the remote user is billed in advance of the requested narrowcasting.

For example, the remote user may be billed, in accordance with the location where the religious activity is performed, the rank of priest who carries out the religious activity, the time when the religious activity is carried out, the weekday on which the religious activity is carried out (say having higher rates for activities to be performed on Sunday), the date the religious activity is carried out on (say having higher rates for activities to be performed on Christmas eve), etc. The various options may be presented in grid form on the webpage or in any other suitable manner.

Preferably, the user is billed for a donation. More preferably, the user is allowed to determine the recipient of the donation, say using a multiple choice interface implemented in a web site, where the user is allowed to choose amongst a predefined list of organizations or projects (say for a mission in Africa, etc).

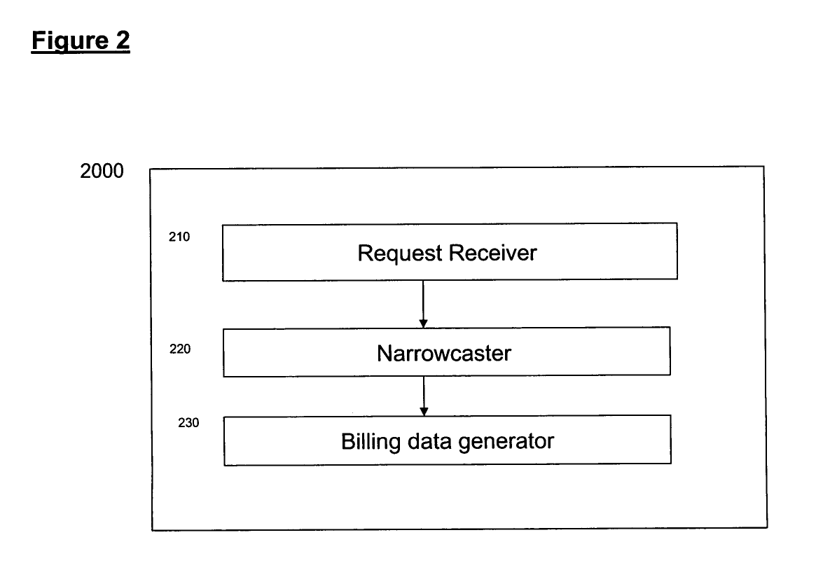

Reference is now made to FIG. 2, which is a simplified block diagram illustrating an apparatus for narrowcasting performance of a religious activity, according to a preferred embodiment of the present invention.

Apparatus 2000 includes a request receiver 210.

The request receiver 210 receives one or more request(s) for narrowcasting one or more religious activities, from a respective remote user.

The request receiver 210 may receive the request through a web site, as described in further detail hereinbelow.

In the web site the remote user may be allowed to choose which activity is to be performed. The remote user may also be allowed to choose where the activity is to be performed. The remote user may also be allowed to choose in what time frame(s) of available time frames, predefined for the place where the remote user wishes the religious activity to be performed, is the activity to be performed, etc.

For example, the request receiver 210 may allow a believer, in Dallas to send a request to have a candle lit, in memory of his grandfather, at the Basilica of the Annunciation, in Nazareth, on a certain date, at a certain hour.

The apparatus 2000 further includes a narrowcaster 220, connected to the request receiver 210.

The narrowcaster 220 narrowcasts 120 the religious activity to the remote user. Optionally, the narrowcaster 220 narrowcasts 120 the religious activity to other uses, say to family members or friends of the remote user. Preferably, the remote user may be allowed to choose or determine whom the religious activity is to be narrowcast to, say through a web site, as described in further detail hereinbelow.

The apparatus 2000 further includes a billing data generator 220, associated with the narrowcaster 220.

The billing data generator 220 generates billing data pertaining to the narrowcasting of religious activity. The billing data may be used to bill the remote party who requests the narrowcasting of the religious activity.

Preferably, the user is billed for a donation.

For example, the user may be billed in accordance with the location where the religious activity is performed, the rank of priest who carries out the religious activity, the time the religious activity is carried out in, the weekday on which the religious activity is carried out, the date on which the religious activity is carried out, etc, as described in further detail hereinabove.

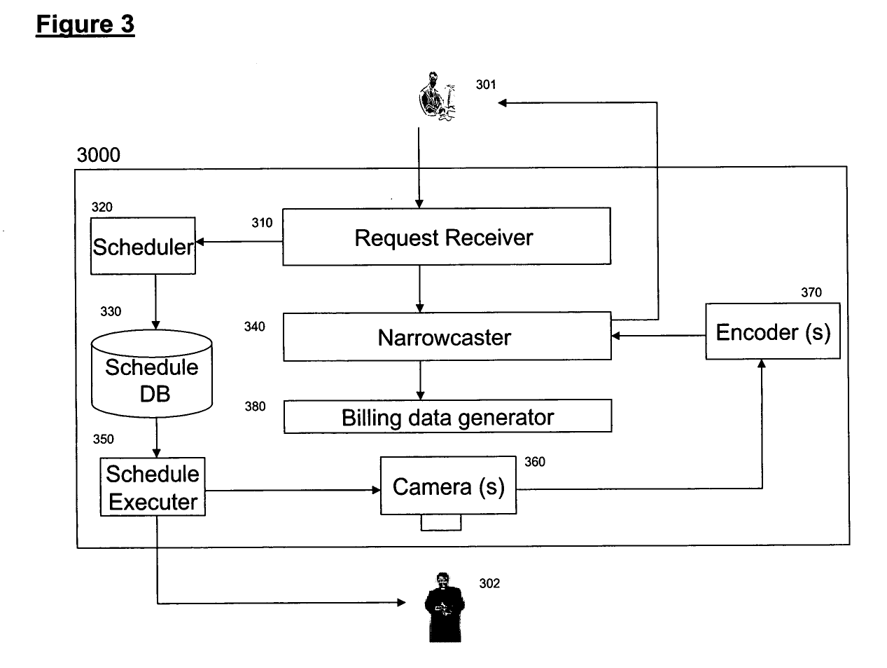

Reference is now made to FIG. 3, which is a second simplified block diagram illustrating an apparatus for narrowcasting performance of a religious activity, according to a preferred embodiment of the present invention.

Apparatus 3000 includes a request receiver 310.

The request receiver 310 receives one or more request(s) for narrowcasting one or more religious activities, from a respective remote user 301.

The request receiver 310 may receive a remote user's request through a web site, as described in further detail hereinbelow.

In the web site the remote user 301 may be allowed to choose which activity is to be performed, where the activity is to be performed, in what time frame(s) of available time frames the religious activity is to be performed, who performs the activity, etc. The web site may be associated with one particular location or it may provide a general service to a particular religious organization and offer numerous locations at which such services may be performed.

Preferably, apparatus 3000 further includes a scheduler 320, connected to the request receiver 310.

The scheduler 320 receives the request and schedules the religious activity chosen by the remote receiver 301, in accordance with predefined time frames, for performing the religious activity.

Preferably, the scheduler 320 records data of the schedule of requested religious activities in a schedule database 330. For example, the schedule database 330 may be implemented as regular relational database, as an object oriented database, etc, as known in the art.

Preferably, the time frames are predefined, say by operators of the apparatus 3000, or by representatives of parties who perform the activities (say a secretary in a certain church, by a priest who performs the requested religious activities, etc).

Different time frames may be defined for different churches, priests, dates, hours, etc, and recorded in the schedule database as available time frames. Optionally, each time frame has a predefined number of activities of predefined types. For example, a certain time frame may be defined as including one candle lighting activity and five blessing activities.

Preferably, apparatus 3000 further includes client agents, installed at premises of performing parties such as a certain church, a specific priest 302 in a certain church, etc.

Using the client agent, each performing party may be able to define time frames, for performance of religious activities, download religious activities scheduled to be performed by the performing party, say for a certain day or week, etc.

Apparatus 3000 further includes a narrowcaster 340, connected to the request receiver 310.

The narrowcaster 340 narrowcasts the religious activity to the remote user 301.

Optionally, the narrowcaster 340 also narrowcasts the religious activity to other uses, say to family members or friends of the remote user. Preferably, the remote user may be allowed to choose or determine whom the religious activity is to be narrowcast to, say through a web site, as described in further detail hereinbelow.

Preferably, apparatus 3000 further includes a schedule executer 350, for executing the schedule of religious activities requested by remote users.

Preferably, the schedule executer 350 executes the schedule of religious activities, using the schedule database 330.

The schedule executer 350 sends a schedule of religious activities, to performing party 302. For example, the schedule of religious activities, to be performed in the Basilica of the Nativity, may be sent to the Basilica of the Nativity or to a specific priest 302 who serves in the Basilica of the Nativity, in accordance with the requests made by the remote users 301.

Optionally, the schedule may be received using a client installed at the premises of the Basilica, say on the priest's personal computer, as described in further detail hereinabove.

Preferably, the schedule executer 350 further triggers one or more capture devices 360 (say a video camera, microphones, etc), in the chapel where a religious activity is to be performed, to capture the religious activity.

Preferably, apparatus 3000 also includes one or more encoders 370, connected to the capture devices 360.

The encoder 370 encodes the captured activity in a high density streamlining data format. For example, the encoder 370 may be a dedicated server, installed with a preprogrammed utility module. The utility module may use any known in the art method for data compression.

The encoder 370 forwards the captured activity to the narrowcaster 340. The narrowcaster 340 sends the captured activity, to the remote party 301 who requested the forwarding.

Optionally, the captured activity is also forwarded to other remote receivers, chosen by the remote receiver 301, as described in further detail hereinabove.

Preferably, apparatus 3000 also includes a billing data generator 380, connected to the narrowcaster 340.

The billing data generator 380 generates billing data pertaining to the narrowcasting of religious activity. The billing data may be used to bill the remote party 301 who requested the narrowcasting of the religious activity.

For example, the user may be billed in accordance with the location where the religious activity is performed—say the central chapel of the Basilica of the Annunciation, in Nazareth, or the church of the Holy Sepulcher in Jerusalem, the rank of priest 302 who carries out the religious activity, the time when the religious activity is carried out, the weekday on which the religious activity is carried out, the date on which the religious activity is carried out, etc, as described in further detail hereinabove.

As discussed above, an apparatus and method, according to a preferred embodiment of the present invention, may be implemented in an Internet site (web site).

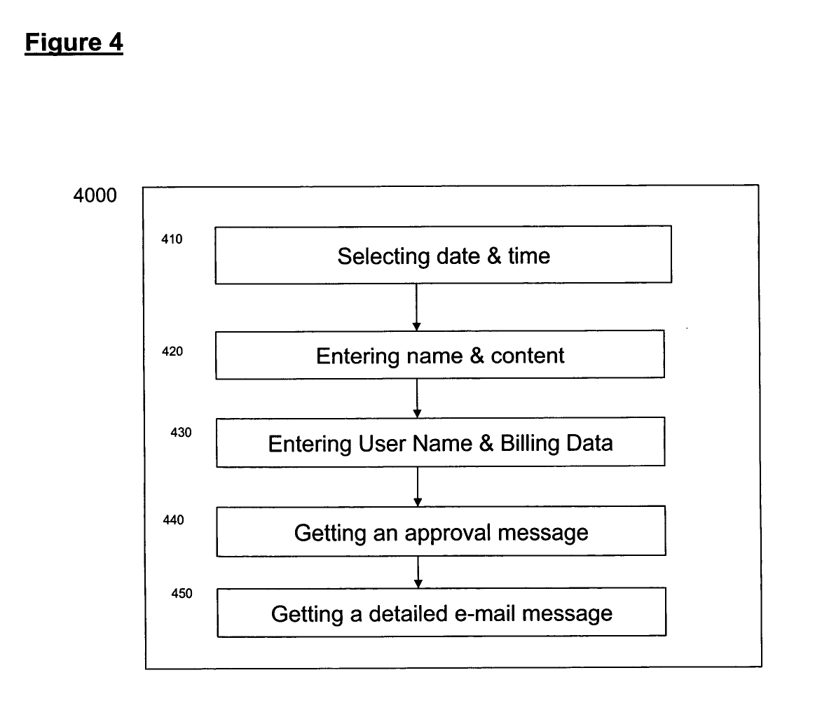

Reference is now made to FIG. 4, which is a simplified flowchart illustrating a method for ordering narrowcasting performance of a religious activity, using a web site, according to a preferred embodiment of the present invention.

Preferably, the web site is connected to the schedule database 330.

According to method 4000, implemented in a web site, using the database 330, the remote user may be presented time frames, shown which are available and which are not, and choose when, where, and by whom, a religious activity requested by the remote user is to be performed and narrowcast.

For example, the remote user may select 410 a date and an exact time frame (say an hour), for a candle to be lit, in memory of his father, in the Basilica of the Annunciation.

Preferably, the remote user is also allowed to provide a list of remote receivers, the religious activities are to be narrowcast to, say a list of messenger e-mail addresses, IP addresses, or registered users of the web site, as known in the art. The list may include the remote user himself. The list may further include other remote parties (say relatives or friends of the remote user).

The remote user may enter 420 the name of a person to be blessed, and a specific content for the blessing, to be said by a priest, in the remote user's name, when lighting the candle.

The remote user may select 430 a user name and provide 430 personal billing data, such as the remote user's credit card number, a preferred payment method—using credit card, a bank account transfer order, etc.

Finally, the remote user receives 440 an approval message for his order, and an e-mail message is sent 450 to the remote user, with the details of the user's order.

From the moment the remote user orders the narrowcasting of the religious activity, the user may log into the web site, open a web cast page in the web site, and see a timer which counts backwards to the time when the activity is performed.

Fifteen minutes before the activity requested in the order is performed, a web camera window is opened and the remote user is allowed to watch the church live from one or more cameras.

When the priest starts performing the religious activity, the remote user is presented a video stream originating from a camera installed at the chapel where the activity is carried out, and positioned where the priest lights the candles.

At the exact hour when the religious activity starts, the remote user is able to see and hear the priest.

The priest lights the candle, and/or says a general prayer, and/or says the name the remote user enters for the blessing. Then, the priest recites any content the user wishes to be included in the blessing. Optionally, the priest says other blessings, according to requests of one or more other remote users, and the live narrowcast ends.

Preferably, the remote user may also receive (say in an e-mail message) a web link. The remote user may use the web link, for downloading a copy of the narrowcast religious activity, as known in the art.

The church, or a specific priest in the church, receives a time schedule of religious activities to be performed for remote users, in the church, as described in further detail hereinabove.

Preferably, in a church where the religious activities are performed, there are installed cameras that are connected to video servers, servers that connect to the Internet network via a wide band communications line, printers, etc. Preferably, the servers connected to the Internet communicate with servers deployed in different geographical locations, for monocasting, narrowcasting, or broadcasting the religious activities.

It is expected that during the life of this patent many relevant devices and systems will be developed and the scope of the terms herein, particularly of the terms “Internet” and “Web site”, “camera”, “Microphone”, “e-mail”, “IP Address”, is intended to include all such new technologies a priori. Herein, the term “ecclesiastical” refers principally to the church but not exclusively so and the claims that follow are intended to cover acts and places sacred to any and all religions.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. Method for narrowcasting performance of a personalized ecclesiastical act at an ecclesiastically significant location, the narrowcasting being over a network, the method comprising the steps of:
a) receiving at said ecclesiastically significant location at least one request for performing a personalized ecclesiastical act, from a respective remote user;
b) at said ecclesiastically significant location performing said ecclesiastical act;
c) narrowcasting the performance of said ecclesiastical act to said remote user; and
d) billing said remote user for said narrowcasting.

2. The method of claim 1, wherein said billing is for a donation.

3. The method of claim 2, further comprising allowing the user to determine a recipient of said donation.

4. The method of claim 1, wherein said narrowcasting utilizes video media.

5. The method of claim 1, wherein said narrowcasting utilizes audio media.

6. The method of claim 1, wherein said request comprises a preferred schedule for said narrowcasting, and said performing is carried out, in accordance with said preferred schedule.

7. The method of claim 1, wherein said request comprises a request to perform the activity, and the method further comprises sending data pertaining to said request to a performing party, thereby instructing said performing party to perform the ecclesiastical act in accordance with said request.

8. The method of claim 1, wherein at least one of the steps is carried out utilizing at least one of a web site and a webcam, and a website offering a plurality of webcam options.

9. The method of claim 1, wherein the ecclesiastical act comprises at least one of the group consisting of praying, blessing, lighting a candle, and taking a service.

10. The method of claim 1, further comprising reporting time of performance of the ecclesiastical act to said remote party.

11. The method of claim 1, further comprising reporting time of performance of the ecclesiastical act to said remote party, as a count backwards to said time.

12. The method of claim 1, further comprising managing an over all schedule for a plurality of ecclesiastical acts.

13. The method of claim 1, wherein said narrowcasting comprises monocasting.

14. An apparatus for narrowcasting performance of a personalized:d ecclesiastical act at an ecclesiastically significant location, the narrowcasting being over a network, the apparatus comprising:
a) a request receiver, configured to receiving at least one request for narrowcasting performance of a personalized ecclesiastical act at the ecclesiastically significant location, from a respective remote user;
b) a narrowcaster, associated with said request receiver, and configured to narrowcast performance of said personalized ecclesiastical act at the ecclesiastically significant location to said remote user; and
c) a billing data generator, associated with said narrowcaster, and configured to generate billing data, usable for billing said remote user for said narrowcasting.

15. The apparatus of claim 14, wherein said billing is for a donation.

16. The apparatus of claim 15, further comprising allowing the user to determine a recipient of said donation.

17. The apparatus of claim 14, further comprising at least one capturing device, configured to capture the performance of said personalized ecclesiastical act at the ecclesiastically significant location.

18. The apparatus of claim 17, further comprising an encoder, associated with said capturing device, and configured to encode said captured activity in a high density streamlining data format.

19. The apparatus of claim 14, further comprising a scheduler, configured to schedule performance of said personalized ecclesiastical act at the ecclesiastically significant location.

20. The apparatus of claim 14, further comprising a scheduling database, for recording a schedule of a plurality of ecclesiastical acts in at least one of a plurality of predefined time frames.

21. The apparatus of claim 14, further comprising a scheduling database, for recording a schedule of said narrowcasting.

22. The apparatus of claim 14, further comprising a schedule executer, configured to send a performing party a schedule comprising at least one ecclesiastical act, said performing party is required to perform, thereby executing the schedule.

23. The apparatus of claim 14, further comprising a schedule executer, configured to trigger operation of a capturing device, for capturing performance of said personalized ecclesiastical act at the ecclesiastically significant location, thereby executing the schedule.

24. The apparatus of claim 14, further comprising a client agent, installed at premises of a performing party, and configured to receive a schedule comprising at least one personalized ecclesiastical act, said performing party is required to perform.

25. The apparatus of claim 14, wherein said narrowcaster is configured to monocast the performance of said personalized ecclesiastical act to said remote user.

26. Method for narrowcasting performance of an ecclesiastical act at an ecclesiastically significant location, the narrowcasting being over a network, the method comprising the steps of:
a) receiving at least one request for narrowcasting performance of an ecclesiastical act, from a respective remote user;
b) at said ecclesiastically significant location performing said ecclesiastical act;
c) narrowcasting the performance of said ecclesiastical act to said remote user; and
d) billing said remote user for said narrowcasting.
